(19) United States
(12) Patent Application Publication
(10) Pub. No.: US 2023/0406562 A1
(43) Pub. Date: Dec. 21, 2023

(54) BOTTLE MADE FROM NATURAL FIBRES AND METHOD FOR PRODUCING SUCH A BOTTLE

(71) Applicant: Green Gen Technologies, Toulouse (FR)

(72) Inventors: Severine LAURENT, Toulouse (FR); James DE ROANY, Toulouse (FR)

(21) Appl. No.: 18/252,441

(22) PCT Filed: Oct. 28, 2021
(86) PCT No.: PCT/FR2021/051897

§ 371 Date: May 10, 2023

(30) Foreign Application Priority Data
Nov. 10, 2020 (FR) FR2011531
Aug. 20, 2021 (FR) FR2108799

(51) Int. Cl. B65D 1/02; B29C 45/00; B29C 48/00

(52) U.S. Cl. CPC B65D 1/0207; B65D 1/0276; B29C 45/0005; B29C 48/022; B29L 2031/7158

(57) ABSTRACT

Bottle made from a shell comprising a body, a bottom and a neck, the bottle being characterised in that the shell is made of a composite material of a knitted fabric of natural fibres combined with thermoplastic material, the shell being shaped and stabilised by thermocompression, the web being a sock with a closed bottom and having a variable section leading up to the neck, depending on the shape the bottle is to have.

The invention concerns a bottle made of natural fibres and the method of making such a bottle.

### FIELD OF THE INVENTION

The present invention relates to a bottle having a wall comprising a bottom, a body and a neck.

The invention also relates to a method of making such a bottle.

The bottle according to the invention is a general term encompassing all shapes of bottles, flasks and jars, generally of glass or plastic, whether rotationally symmetrical or not, with round, rounded or polygonal cross-section, varying from the bottom to the neck opening.

The shape of all these bottles, between the bottom and the neck openings, comprises a flat or punted bottom, a body joined to the neck by a shoulder and provided with a ring or a screw ring or cap ring to receive a stopper, a cap or a lid.

As far as the general shape is concerned, the various parts of the bottle are more or less accentuated or attenuated, with a taller or shorter body, a more or less marked shoulder, a longer or shorter neck and a ring or other relief arrangement designed to receive a stopper such as a cork or a cap or a screw-on or screw-off capping means

### STATE OF THE ART

Traditional glass bottles, flasks and jars come in many shapes and sections. The disadvantage of glass bottles is that the manufacturing process requires high temperatures for melting and shaping the glass.

There is also a bottle shown in document FR17 62 244 which is formed from a braid combined with a plastic material for its assembly. But this bottle requires the bottom and the neck to be made separately and then assembled together while the possibilities in terms of the shape are limited by the braiding. Although this bottle has advantages in manufacturing and use, its multi-part construction makes it relatively complicated to manufacture and the braiding sets a limit on the possibilities of bottle shapes.

### Purpose of the Invention

The purpose of the present invention is to develop a bottle that is easy to manufacture, which can be produced at relatively low temperatures compared to the temperatures required for producing glass bottles, which are light and reusable, and which allow a wide variety of shapes to suit the application.

### Abstract and Advantages of the Invention

For this purpose, the object of the invention is a bottle with a wall made up of a base, a body and a neck, characterised in that the composite material wall consists of natural fibres knitted together combined with thermoplastic material, the wall being shaped and stabilised by injection, moulding or thermocompression, the knit being a sleeve closed by a base and having a variable cross-section rising towards the neck, depending on the shape of the bottle.

The bottle according to the invention offers the advantage of being very simple to manufacture whatever the particular shape of the bottle or of its various parts: a more or less symmetrical neck, a flat bottom or a punted bottom, a body with a round, oval, polygonal section or combining various sectional shapes in its height, a more or less accentuated shoulder, and a long or a very short neck in the case of jars or flasks. The bottle may also have a smooth ring like that of traditional bottles closed by a stopper, whether made of cork, synthetic materials or glass, or a threaded ring fitted with a screw-on cap, or a raised ring to clip onto a lid or cap, as in the case of soft drink caps, for instance.

The knit structure offers the advantage of transferring the stresses produced by local deformations from stitch to stitch so that the assembly balances and the mesh links are evenly distributed.

Furthermore, the bottle offers the advantage of being made with a knitted material forming the entire wall of the bottle, from its bottom, whether flat or punted, all the way up to the mouth of the neck.

This bottle is simple and economical to make since the manufacturing temperature is near the melting temperature of the thermoplastic material for the impregnation of the knitted material and allows the final shaping and stabilisation of this shape by moulding, compression, bonding or thermocompression.

The bottle made in this way can also be coated on the inside if necessary for some types of liquids.

The bottle made in this way is also recyclable or can be used as industrial compost.

According to one characteristic, the knitted material comprises at least one of the following items: a flat bottom part, a punted part, a body part, a shoulder part, a neck part and a ring part for a smooth ring or for a screw ring.

These items can vary in size and shape depending on the nature of the bottle, i.e. whether it is a relatively narrow or wide-necked bottle, ranging in shape from traditional bottles to fancy bottles, jars or flasks.

The ring is also adapted to permit various closing movements including a mechanical closure for cylinders containing a carbonated liquid.

The invention also concerns a method for producing a bottle like this, being characterised in that, after an initial stage, the natural fibre yarn is fed in and used to knit a sleeve-shaped knitted material structure having a base and whose shape corresponds to that of the bottle to be produced, the thermoplastic material being combined with the knitted material, whereupon the knitted material, combined with the thermoplastic material, is shaped by thermoforming.

According to another variant, the knitted material is combined with a. the thermoplastic material by means of a glue made of polyvinyl acetate (PVA), polyvinyl alcohol (PVOH) or biosourced glue based on casein, starch, chitin, chitosan, alginate, lignin, or wax.

In yet another variant, the assembly of the knitted material and the shell is done by means of a film of the same type as the shell and which is heat shrinking. The advantage of these two variants is that at the end of the bottle's life, the linen knit is separable from the thermoplastic shell, which facilitates the recycling of both parts of the bottle.

This process is very simple to use and thanks to the knitted material forming the base of the bottle wall, any shapes can be easily achieved by the shape of the knitted material which more or less closely imitates the final shape of the bottle, the elasticity of the knitted material allowing the knitted material to be adapted to the final shape without weakening any part of the wall surface, the knitted material adapting itself by elasticity, evenly to the surface thus covered.

In the above method, the thermoplastic material is bonded to the natural fibre yarn by extrusion, by plastic injection. Each of these two combination methods has its own advantages the choice made usually depends on the shape of the bottle.

According to another characteristic, the invention is a method of combining thermoplastic material with natural fibre yarns by feeding natural fibre yarns and thermoplastic filaments into the knitting process.

The method is particularly simple since it consists in starting with natural fibres and thermoplastic fibres, directly knitted together to join them and then allow, by thermocompression, the fusion and infiltration of the thermoplastic material into the natural fibres to thus form the composite wall,

The invention also concerns a method whereby the natural fibre yarn is combined with the thermoplastic material by combining the natural fibre yarn with thermoplastic filaments to feed the knitting process with the yarn combined in this way.

According to one variant of this process, natural fibres in the form of yarns, ribbons, strands are combined with the thermoplastic material—presented with similar forms to natural fibres by a co-mixing stage to obtain a co-mixed yarn or, the natural fibres are combined with the thermoplastic filaments in a covering step to obtain a covered yarn.

### BRIEF DESCRIPTION OF THE DRAWINGS

This invention will be described below in an embodiment referred to in the accompanying drawings, in which:

FIG. 1 Front view of a bottle in the traditional shape of a wine bottle, according to the invention.

FIG. 2 Front view of the bottle in FIG. 1, cut in half along a median plane.

FIG. 3 Diagram of the process for preparing the bottle according to the invention.

FIG. 4 Diagram of the process for preparing the bottle according to the invention and its variants.

FIG. 5 General diagram of the process according to the invention.

### DESCRIPTION OF THE EMBODIMENTS OF THE INVENTION

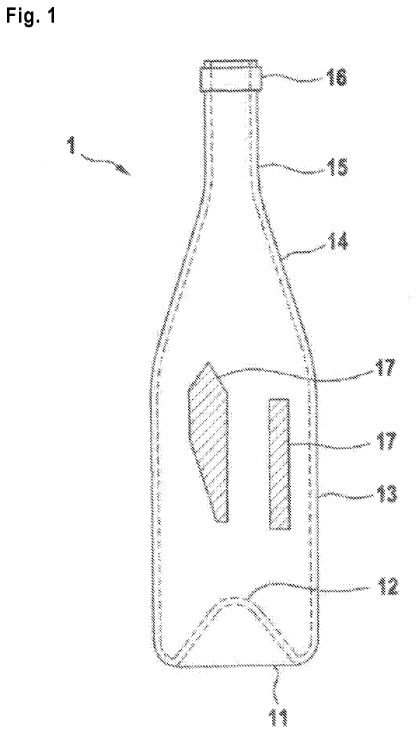

FIG. 1 is a side view of an example of a bottle 1, according to the invention, for a traditional wine bottle with two variants. It is made of a composite material comprising a knit of natural fibres (A) combined with a thermoplastic material (B).

The bottle 1 consists of a body 13 with a bottom 11 with a punt 12 or a flat bottom 11, a shoulder 14 and a neck 15 ending in a ring 16.

The body has patterns 17 in the form of distinctive or decorative items such as an acronym, a mark, an engraving or other distinctive signs. The distinctive items include, for example, a brand name or a distinctive element of a product category. These items are particular shapes given to the composite wall of the bottle and, if necessary, the items integrated in that wall.

Pattern 17 is, for example, formed in the composite mass and may or may not stand in relief from the outer surface of the bottle or the pattern 17 may create a see-through effect or have coloured items giving the mass a distinctive look.

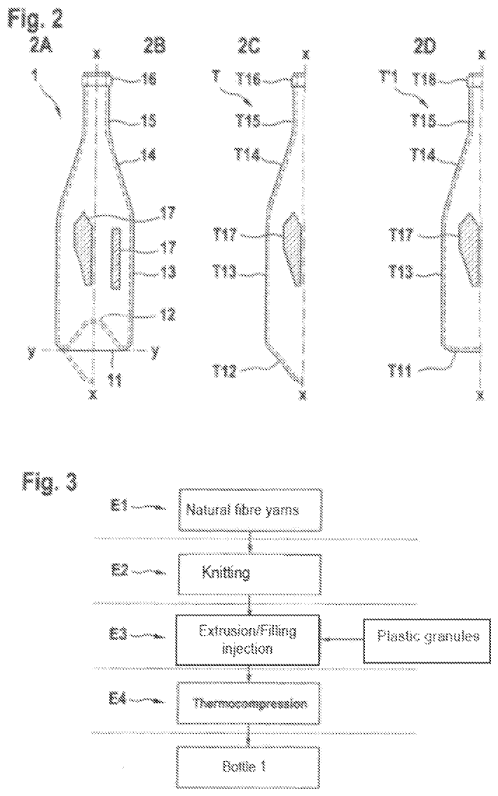

FIG. 2 shows, in its left part 2A, a half-section through a plane passing through the median axis XX and in its right part 2B an uncut view of the bottle 1. The two examples of bottles shown in the half-sectional view correspond to two knitted materials T1, T′1 shown separately in parts 2C, 2D of this FIG. 2.

The two separate parts 2C, 2D reveal the shape of the composite bottle wall made of a knitted material T1, T′1. The knitted materials will be impregnated with a thermoplastic material to highlight the shape of the composite bottle wall formed by a knitted material T1, T′1 at least substantially in the shape of a bottle. They will be impregnated with a thermoplastic material to create a sealed, stable wall, in a single section between the bottom 11 and the neck opening beyond the ring 16.

Part 2C shows the shape of the knitted material T1, which consists of an open sleeve at one end and closed at the other end by the bottom T11 with a punt T12. Moving up towards the collar, the knitted material T1 is in the shape of the body T13 and then the that of the shoulder T14 followed by the neck T15 and the ring T16 with the overlaid thickness. As shown in this part 2C representing a cross-section of the knitted material T1, the surface of the knitted material is uneven as it is not yet combined with the thermoplastic material and its shape has not been stabilised by thermocompression.

According to part 2D, the knitted material T′1 variant for a flat-bottomed bottle consists of the flat bottom part T11, the body part T13, the shoulder part T14, the neck part T15 and the ring part T16.

In both cases, the knitted materials T1, T′1 bear part of the pattern T17.

The knitted material T (T1, T′1) has a flat bottom T11 for a flat-bottomed bottle or a shape T12 for a bottle with a punt. This shape consists of a dome-shaped extension beyond the plane YY of the bottom. The knitted material T (T1, T′1) has a variable cross-section with respect to the XX axis. In the deployed state, the shape of T12 corresponds substantially to the symmetrical shape of the punt 12 with respect to the plane YY of the bottom perpendicular to the axis XX of the bottle.

The cross-section of the knitted fabric T (T1, T′1) corresponds to that of the body T13 and then decreases with the shape of the shoulder T14 up to the neck T15 and ends with the ring T16 with an extras thickness of knitted material at the ring, while conversely, the thickness of the wall and thus that of the knitted fabric is constant.

Relief effects due to an extra thickness are incorporated into the mass. Depending on the case, these thicknesses can be obtained by moulding and with a knitted material modified according to the relief by patterns T17.

The knitted material T (T1, 71) is knitted to have a regular, equal density over the entire surface of the wall of bottle 1, except where the extra thickness is modified for the ring or for patterns.

The thickness of the wall and therefore of the knitted material T depends on the nature of the liquid with which the bottle is to be filled, whether the liquid is pressurised or not.

The knitted material T forming the wall of the bottle is made by combining natural fibre yarns (A) before or after knitting with plastic material (B) combined with natural fibre yarns, by thermocompression to obtain and stabilise the final shape of the bottle 1.

As already indicated, the term bottle includes all special forms of bottles, in particular bottles, jars of food liquids other than those traditionally packaged in bottles (wine, alcohol) or food or cosmetic gels, as well as the prismatic shapes used for fruit juices or liquids of this type. The shape of the knitted material T will be adapted to/copied from the shape of the bottle to be made, taking into consideration the elasticity of the knitted material T when it is placed in a mould.

FIG. 3 is a schematic diagram of a first example P1 of a process for manufacturing a bottle 1 according to the invention. Starting from the natural fibre yarns (A) feeding (feed stages E1) the knitting stage (E2), a knitted material T is knitted in the general shape of the bottle to be made, for example the shape of the bottle shown in FIGS. 1, 2.

The knitted fabric T is then coated with plastic (step E3), either by extrusion (step E31) or by injection (step E32) or by rotational moulding (E33). These operations consist of pressing the natural fibre yarn knitted material (A) against the wall of the mould to take the shape of the bottle by impregnating the extruded thermoplastic material into the mould or rotational-moulded in the mould already lined with knitted material T or as an injected plastic preform which is expanded in the mould already lined with knitted fabric T.

In another variant, the thermoplastic shell is made beforehand by injection moulding, extrusion or rotational moulding and a knitted material is laid on the thermoplastic shell.

In another variant as a way of joining the thermoplastic shell to the knitted material, a thin, thermoplastic, heat-shrinkable film is placed between the thermoplastic shell and the linen knitted material or over the thermoplastic shell and the knitted fabric whereupon the film shrinks on contact with hot steam.

The shape of the bottle 1, is finished and stabilised in step E4 after thermocompression. In one variant, the assembly and consolidation of the thermoplastic shell and the knitted material is done by impregnation with glue. In a second variant, the thermoplastic shell is covered with a heat-shrinkable film and knitted material made of natural fibre yarns, with assembly and consolidation obtained by means of hot steam which shrinks the film.

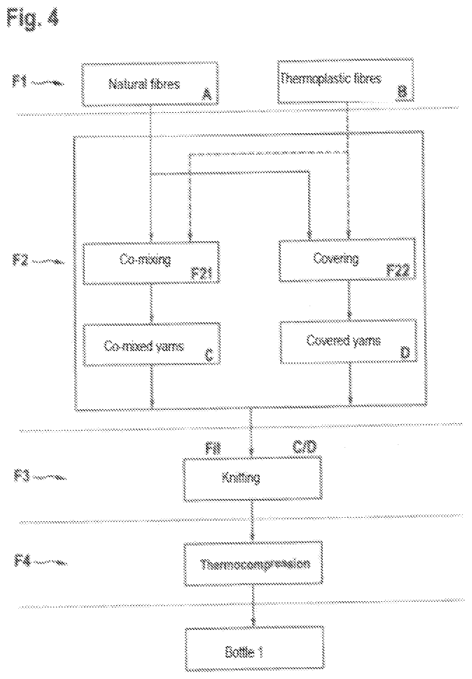

FIG. 4 shows a second process which combines natural fibre yarns (A) with thermoplastic filaments (B) by knitting. The resulting knitted material T is then shaped and stabilised by thermocompression to obtain the bottle 1.

This process P2 consists of natural fibre yarns (A) and of thermoplastic filament yarns (B) or simple thermoplastic filaments (B) to make the knitted material T by directly feeding the knitting step (F3) with these two types of yarns (A) and yarns or filaments (B).

In a first variant P3 of the second method, the feeding step F1 is followed by a combining step F2 consisting of co-mixing F21 the natural fibre yarns (A) and the thermoplastic yarns or filaments (B) to obtain a co-mixed yarn (C) which feeds the knitting step F3. This is followed by the thermocompression step F4.

In a second variant P4 of the second method, the combining step F2 consists of covering F22 the thermoplastic filaments (B) on the natural fibre yarn (A) to obtain a covered yarn (D) which then reaches the knitting step F3 followed by the thermocompression step F4.

In other words, this intermediate step consists of combining the two types of yarns (A), and filament yarns (B), to feed the knitting step with the yarn (C) resulting from this preliminary combination of the two yarns A, B.

In brief,
the method consists in knitting E2 natural fibre yarns (A) and then adding to the knitted material (T) the thermoplastic material (B) for shaping by thermocompression, moulding, gluing and heat shrinking,
the method may also involve joining the natural fibre yarns A and thermoplastic filament yarns B by knitting and then shaping and stabilising the knitted material T combined with the plastic material by thermocompression.

The method may also include an intermediate combination step F2 consisting in:
making to make co-mixed yarns (step F21) by joining natural fibres A with thermoplastic material B, the co-mixed yarns C then being knitted or,
producing covered yarns (covering step F22) by covering thermoplastic filaments B on natural fibre yarns A to obtain a covered yarn (D) which will then be knitted (step F3) and thermocompressed (step F4).

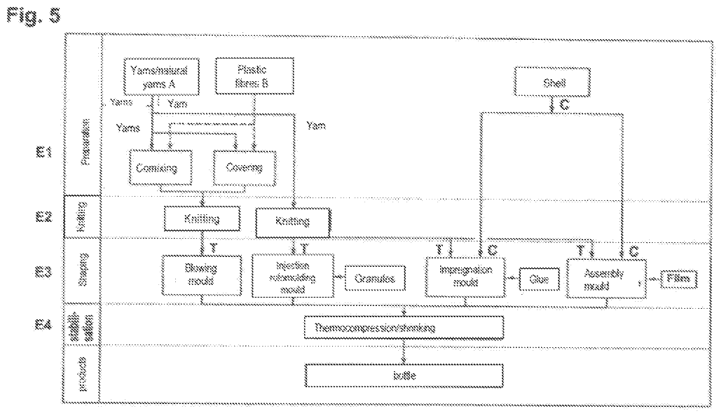

FIG. 5 shows the synthesis of the process of making a bottle as follows:
E1) starting from natural fibre yarns or natural fibre yarns and thermoplastic fibre yarns or from a thermoplastic shell,
E2) a knitted material T is made from yarns of natural fibres alone or with yarns combining natural fibres and plastic fibres,
E3) the bottle blank is assembled,
   by extrusion of plastic material from granules in the mould already lined with knitted material T
   by rotational moulding in a mould lined with knitted material T
   by impregnating a shell C lined with knitted material in a mould with glue by joining in a mould the knitted material T to a plastic shell C with interposition or coating of a heat-shrinkable film of the knitted material on the shell or between the knitted material and the shell
E4) wherein the shape is stabilised by thermal action, that is by thermocompression with soft steam or by thermocompression obtained by shrinking the film.
   In other words, and following the diagram in FIG. 5, from natural fibre yarns A, a knitted material T is knitted and placed in a mould into which plastic material is then injected or applied by rotational moulding. The resulting blank is then stabilised by thermocompression or
   starting from natural fibre yarns A, a knitted material T is made which is placed in a mould to be impregnated with glue and to obtain the blank which is stabilised by thermocompression to obtain the bottle or
   starting from the natural fibre yarn A, a knitted material is made and placed in a mould assembled with a shell and the knitted material is impregnated with glue to stabilise the shape by thermocompression.

Starting from the natural fibre yarn A, a knitted material T is made, placed in a mould to be assembled to a shell C with an interposed heat-shrinkable film or coating of the knitted material with a heat-shrinkable film, then thermocompression is carried out by heat-shrinking the film to obtain the bottle.

In another variant, with the natural fibre yarn A and the plastic fibres a yarn is produced either by co-mixing the two yarns or by covering. The resulting yarn is then knitted and placed in a mould for shaping by inflation then stabilisation by thermocompression to obtain the product.

### NOMENCLATURE OF MAIN ITEMS

1. Bottle
11. Base
12. Punt
13. Body/cylinder
14. Shoulder
15. Neck
16. Ring
17. Pattern
A Natural fibres
B Thermoplastic material
C co-mixed yarn
D Covered yarn
T knitted material
T12 Punt part
T13 Body part
T14 Shoulder part
T15 Neck part
T16 Ring part
T17 Pattern part
T′1 Knitting variant
T11 Flat bottom part
T13 Body part
T14 Shoulder part
T15 Neck part
T16 Ring part
T17 Pattern part
P1 First manufacturing method
E1 Yarn in-feed step
E2 Knitting step
E3 Hot-melt material combination step
E31 Extrusion combination step
E32 Injection combination step
E4 Bottle blank thermocompression
P2 Second manufacturing method
F1 yarn/filament A-B feed
F3 Knitting step
F4 Thermocompression step
P3 first variant of second method
F1 yarn/filament A-B feed
F21 co-mixing step
F3 Knitting step
F4 Thermocompression step
F21 co-mixing step
F22 covering combination step
P4 second variant of second method
F1 Yarn/filament supply A-B
F22 covering combination step
F3 Knitting step
F4 Thermocompression step

1. A bottle with a wall comprising a base, a body and a neck, a bottle characterised in that
the wall of composite material is made of a knitted material of natural fibres combined a thermoplastic material, the wall being shaped and stabilised by injection, moulding or thermocompression,
the knitted material being a sleeve formed by a bottom and having a variable cross-section rising towards the neck, depending on the shape of the bottle.

2. The bottle according to claim 1, characterized in that
the knitted material comprises at least one of the following items: a flat bottom part, a punted part, a body part, a shoulder part, a neck part and a ring part for a smooth ring or for a screw ring.

3. A method of making a bottle according to claim 1, characterized in that
by an initial step natural fibres are fed in,
a sleeve-shaped knitted material with a bottom is knitted with this yarn, the shape of which corresponds to that of the bottle to be made,
the thermoplastic material is combined with the knitted material and,
the knitted material combined with the thermoplastic material, is shaped by a thermoforming, moulding, bonding, heat-shrinking step.

4. The method according to claim 3, characterized in that
thermoplastic material is combined with natural fibres by extrusion or injection of thermoplastic material.

5. The method according to claim 3, characterized in that
the natural fibres (A) are combined with the thermoplastic material feeding the knitting step with natural fibres and thermoplastic.

6. The method according to claim 3, characterised in that
the natural fibres are combined with the thermoplastic material (B) by combining the natural fibres with the thermoplastic material to feed the knitting step with the yarn combined in this way.

7. The method according to claim 6, characterized in that
the natural fibres are combined with the thermoplastic material by a co-mixing step to obtain a co-mixed yarn or,
the natural fibres are combined with the thermoplastic material by a covering step to obtain a covered yarn.

8. A bottle comprising:
(i) a body,
(ii) a base, and
(iii) a neck,
where said body, said base, and said neck include a composite including a thermoplastic material and a knitted material, where said knitted material includes natural fibre yarns.

9. The bottle of claim 8, where at least one of the body, the base, and the neck are stabilized as a result of being shaped by thermoforming, moulding, bonding, or heat-shrinking.

10. The bottle of claim 8, where the knitted material is a sleeve including a bottom, a sidewall, and a neck, and wherein the cross-sectional diameter of the sidewall is variable between the bottom and the neck.

11. The bottle of claim 10, where the sleeve further includes a shoulder disposed between the sidewall and the neck.

12. The bottle of claim 10, where the bottom is a flat bottom or a punted bottom.

13. The bottle of claim 10, where said sleeve further includes a ring disposed in the neck, and where the ring is a smooth ring or a screw ring.

14. A method for forming a composite bottle, the method comprising:
(i) providing a pre-finished composite that includes a thermoplastic material and a knitted material, where the knitted material includes natural fibre yarns, and where the knitted material is in the shape of a bottle;
(ii) heat treating the pre-finished composite to form the composite bottle.

15. The method of claim 14, where said heat treating includes thermoforming, moulding, bonding, or heat-shrinking.

16. The method of claim 14, where the pre-finished composite is formed by providing the knitted material and then coating the knitted material with the thermoplastic material.

17. The method of claim 16, where said coating includes extrusion, injection, or rotational moulding of the thermoplastic material onto the knitted material.

18. The method of claim 14, where the pre-finished composite is formed by knitting the natural fibre yarns with thermoplastic filament yarns.

19. The method of claim 14, where the natural fibre yarns are coated with the thermoplastic material.

20. The method of claim 14, where the natural fibre yarns include a combination of natural fibres and thermoplastic filaments.
